(19) United States
(12) Patent Application Publication
(10) Pub. No.: US 2006/0228950 A1
(43) Pub. Date: Oct. 12, 2006

(54) Guard for terminals in a terminal block

(75) Inventors: Emmad A. Jamaleddin, Milwaukee, WI (US); Edward Byaliy, Shorewood, WI (US); James Peter Miller, Waukesha, WI (US)

Correspondence Address: ROCKWELL AUTOMATION, INC./(QB), ATTENTION: SUSAN M. DONAHUE, 1201 SOUTH SECOND STREET, MILWAUKEE, WI, 53204, US

(73) Assignee: Rockwell Automation Technologies, Inc.

(21) Appl. No.: 11/093,984

(22) Filed: Mar. 30, 2005

(51) Int. Cl. H01R 9/22

(52) U.S. Cl. 439/709

(57) ABSTRACT

A terminal block includes a casing configured to support a conducting member of the type that is connected to a first and second terminal. A cover is hingedly affixed to the casing, and iterates between an open position that exposes at least one of the terminals and a closed position that guards the exposed terminal.

### BACKGROUND OF THE INVENTION

The present invention relates to electrical terminal blocks, and in particular relates to a terminal block having a cover that guards an electrical terminal carried by the terminal block.

Electrical terminal blocks are well known structures that typically carry a pair of electrical terminals to provide an interface between a supply or source of electricity and an electrical device. Terminal blocks are typically mounted on a rail or panel and positioned such that electrical leads can be easily connected and disconnected as desired.

Conventional terminal blocks are available in both open and closed configurations (e.g., NEMA and IEC terminal blocks). Referring to FIG. 1, a conventional open terminal block 20 is formed from a casing 22 including a lower portion 24 configured for connection to, for instance, a din rail, and an upper portion 26 that carries a pair of electrical terminals 28. Terminals 28 each include a screw 30 that is fastened in a conductive member 32.

Terminal block 20 is termed “open” because the electrical terminals 28, while recessed with respect to the upper end of the terminal block 20, are nonetheless exposed to the user. This has historically been viewed as advantageous because an abundance of space is available for the user to employ conventional screwdriving means to actuate screw 30 when connecting and disconnecting the associated terminal 28. Unfortunately, open configuration terminal blocks subject the user to potential currents flowing through the exposed electrical terminals.

Closed configuration terminal blocks are configured similar to terminal block 20, however the casing substantially encapsulates the terminals to limit a user's access to the terminals. Closed terminal block casings further define through holes extending therethrough that are aligned with the terminals and enable the user to access to the terminals with a conventional screwdriving means when connecting and disconnecting electrical leads. Closed terminal blocks therefore require a user to have appropriate tooling in order to access the terminals, and thus reduce the ability of unauthorized personnel from connecting and disconnecting the terminal block. The casing further protects the user from accidentally touching terminals carrying electrical current with his or her finger. Unfortunately, when mounted on a din rail or other like mounting structure, the casings of conventional closed terminal blocks do not allow the user to easily view the end of electrical leads as they are fastened in the terminals.

It is therefore be desirable to provide a terminal block having a cover that more reliably guards the terminals with respect to direct user access while, at the same time, allowing sufficient visibility when connecting and disconnecting electrical leads to the terminal block.

### BRIEF SUMMARY OF THE INVENTION

In accordance with one aspect of the invention, a terminal block includes a casing configured to support a conducting member of the type that is connected to a first and second terminal. A cover is hingedly affixed to the casing, and iterates between an open position that exposes at least one of the terminals and a closed position that guards the exposed terminal.

The foregoing and other advantages of the invention will appear from the following description. In the description, reference is made to the accompanying drawings which form a part thereof, and in which there is shown by way of illustration, and not limitation, preferred embodiments of the invention. Such embodiments do not necessarily represent the full scope of the invention, and reference should therefore be made to the claims herein for interpreting the scope of the invention.

### BRIEF DESCRIPTION OF THE DRAWINGS

FIG. 1 is a perspective view of a conventional terminal block having an open configuration;

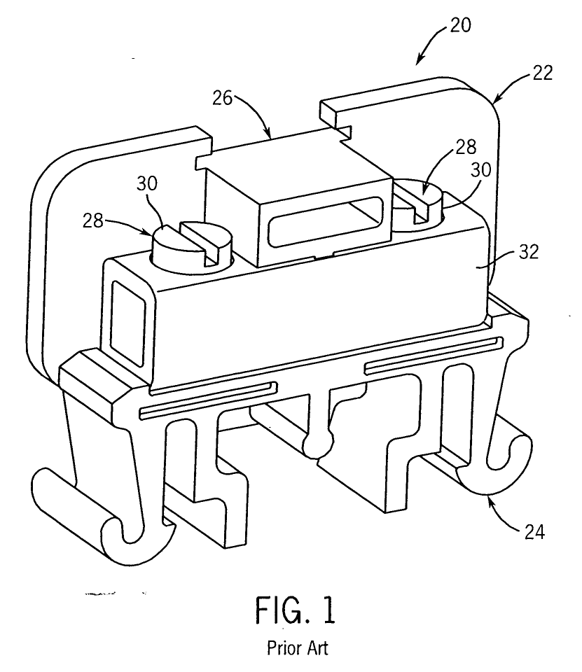

FIG. 2 is a perspective view of a terminal block constructed in accordance with a first embodiment of the present invention having a cover in an open position;

FIG. 3 is a perspective view of the terminal block illustrated in FIG. 2 with the cover in a closed position;

FIG. 4 is a perspective view of a terminal block constructed in accordance with a second embodiment of the present invention; and

FIG. 5 is a perspective view of a terminal block constructed in accordance with a third embodiment of the present invention.

### DETAILED DESCRIPTION OF THE PREFERRED EMBODIMENT

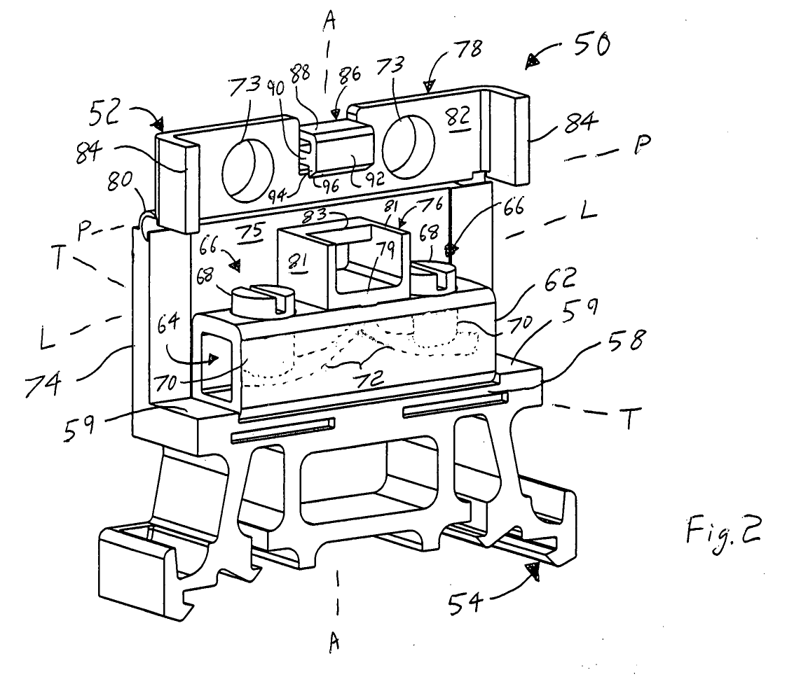

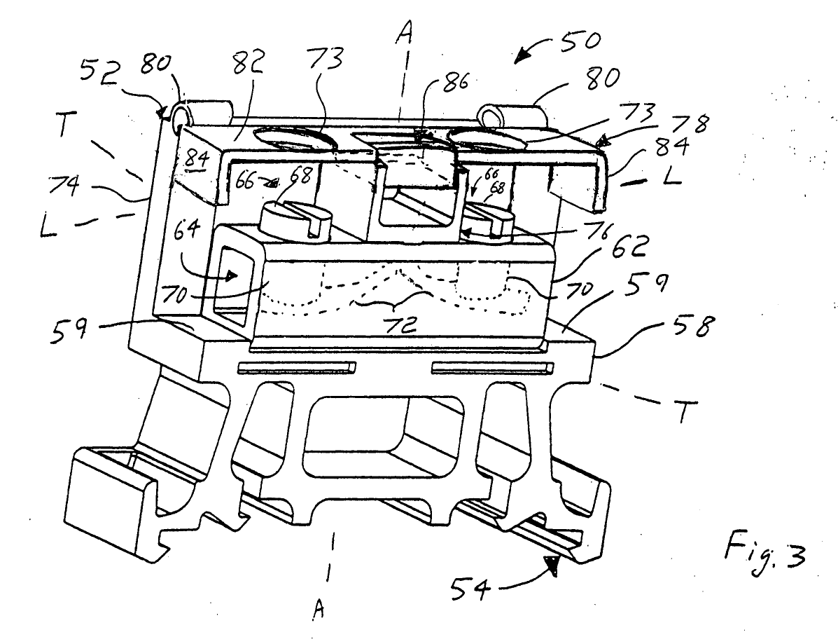

Referring to FIGS. 2-3, a terminal block 50 extends along a longitudinal axis A-A, and includes a casing 52 that can be formed from any suitable material, for instance Nylon 6-6. Casing 52 includes a mounting portion 54 disposed at its lower end including a clamp configured to connect to a din rail extending along a transverse axis T-T, as understood by one having ordinary skill in the art. A horizontal plate 58 defines the upper end of mounting portion 54. Plate 58 is elongated in the direction of a lateral axis L-L that extends perpendicular with respect to longitudinal axis A-A and transverse axis T-T.

Horizontal plate 58 is recessed with respect to a pair of flanges 59 disposed laterally outward with respect to plate 58, and provides a seat for an electrically conducting member 62. Conducting member 62 can be a substantially tubular barrel that defines an opening 64 at each lateral end that receives an electrical lead (not shown) from a supply or source of electricity or an electrical device.

Conducting member 62 defines a pair of terminals 66, each including a screw 68 threadedly inserted into the upper end of conducting member 62. Each screws 68 has a shaft 70 extending downwardly into opening 64 that contacts a flexible conducting pressure plate 72 extending from the upper surface of conducting member 62. The electrical device or power source is thus connected by inserting the lead into a gap disposed between the lower surface of conducting member 62 and pressure plate 72, and subsequently rotating screw 68, using a conventional screwdriving apparatus, until the electrical lead is pinched between the lower surface of conducting member 62 and pressure plate 72 (under force provided by screw shaft 70). While one example of a conducting member has been described, a skilled artisan will appreciate that conducting member 62 can be of any type (for example a conducting cross bar) well known for being suitable for use in terminal blocks.

A vertical end wall 74 extends upwards from plate 58 and defines an inner surface 75 that faces conducting member 62. End wall 74 supports a transverse guide block 76 that extends inwardly from wall 74. Guide block 76 includes a lower horizontal wall 79 that is vertically spaced from plate 58 a distance substantially equal to the height of conducting member 62 such that conducting member 62 fits snugly between plate 58 and block 76. When conducting member 62 is installed, lower horizontal wall 79 is disposed between screws 68. A pair of vertical walls 81 extends upwards from the laterally outer ends of lower horizontal wall 79. An upper horizontal wall 83 extends between the upper ends of vertical walls 81. Wall 83 extends inwardly from inner surface 75 a distance less than lower horizontal wall 79.

Contact block 50 further includes a cover 78 attached to casing 52 via a pair of hinges 80 that can be formed from sections of casing 52 having a reduced thickness so as to render hinges 80 flexible. A skilled artisan, however, will appreciate that any suitable hinge can be used to connect cover 78 to casing 52. In accordance with one aspect of the invention, cover 78 is hingedly connected to the upper end of end wall 74 and can be iterated between an open position and a closed position about a pivot axis P-P that extends parallel to end wall 74. When cover 78 is in the open position, conducting member 62 and terminals 66 are exposed and accessible to a user. When cover 78 is in the closed position (FIG. 3), cover 78 guards conducting member 62 and terminals 66 from being contacted by a user.

Cover 78 includes a laterally extending wall 82 connected to the upper end of end wall 74 via hinges 80. A pair of cylindrical apertures 73 extends through wall 74, each aperture 73 in lateral alignment with a corresponding screw 68. Apertures 73 are sized to allow a conventional screwdriving apparatus to pass through and access screws 68 when cover 78 is closed. A pair of transverse guard arms 84 extends inwardly from opposing lateral ends of lateral wall 82 when cover 78 is open, as illustrated in FIG. 2.

Cover 78 further carries a latch 86 at a free end of the cover 78 (e.g., an end of the cover 78 that is not directly connected to casing 52) that extends inwardly from lateral wall 82 when cover 78 is open (and downwardly from wall 82 when cover 78 is closed). Latch includes an inner wall 88 extending perpendicular to lateral wall 82, and a support wall 90 spaced from inner wall 88 and extending parallel to wall 88. Walls 88 and 90 are connected at their distal ends to an engagement wall 92 having an overhang 94 from support wall 90. Engagement wall 92 presents a beveled outer surface 96 at the overhang 94 to assist when locking cover 78.

During operation, when the electrical power source is discontinued, the user may access terminals 66 with cover 78 in the open position as illustrated in FIG. 2. Prior to activating electrical power through terminal block 50, cover 78 is closed by rotating lateral wall about pivot axis P-P. As cover 78 is rotated, beveled surface 96 of latch 86 cams over upper horizontal wall 83 of guide block 76 until overhang 94 interlocks with wall 83, which provides a catch to lock cover 78 in the closed position illustrated in FIG. 3.

When cover 78 is closed, lateral wall 82 extends slightly above conducting member 62 and inwardly from end wall 74 a sufficient distance to guard conducting member 62 and terminals 66. Likewise, guard arms 84 extend a sufficient distance downward from lateral wall 82 to guard terminals 66 and conducting member 62 with respect to side access when cover 78 is closed.

Advantageously, cover 78 cannot be easily opened by hand, and instead requires a user to insert any suitable biasing member (for example a flathead screwdriver) between inner wall 88 and support wall 90 of latch 86 to force beveled wall away from catch 83 and allow cover 78 to rotate about axis P-P to the open position. It should thus be appreciated that guide block 76 and latch 86 provide a locking mechanism that releasably locks cover 78 in the closed position.

Terminal block 50 therefore requires a user to have appropriate tooling in order to access terminals 66, and thus reduces the ability of unauthorized personnel from connecting and disconnecting leads to the terminal block 50. The casing 52 further guards the user from accidentally opening cover 78. Furthermore, because cover 78 is attached to casing 52 and easily iterated between the open and closed position, the use of cover 78 is intuitive to skilled personnel.

It should be further appreciated that when cover 78 is open, terminal block 50 provides sufficient user visibility of terminals 66 when connecting and disconnecting electrical leads to terminal block 50 without suffering the drawbacks of conventional open terminal blocks. When cover 78 is closed, terminal block 50 affords the protection currently provided by conventional closed terminal blocks without suffering the drawbacks of conventional closed terminal blocks.

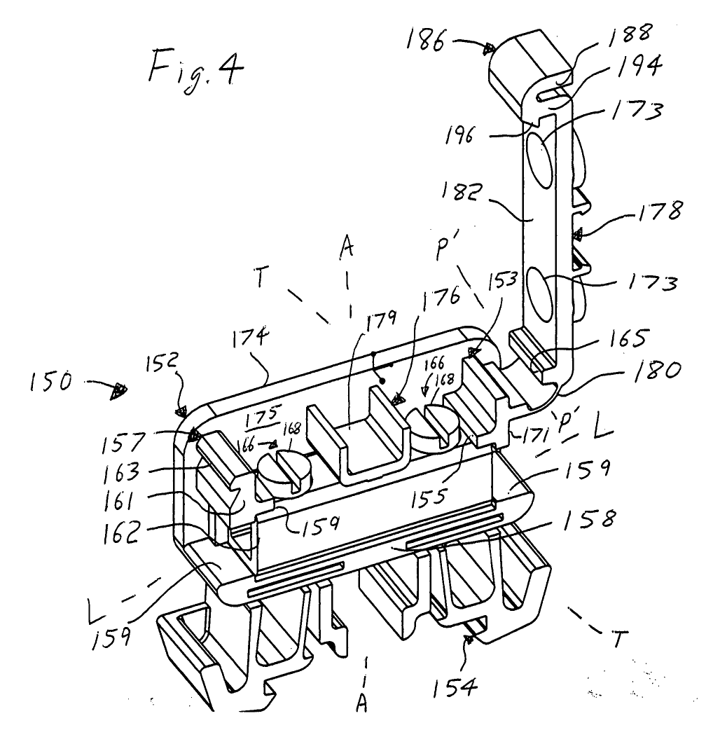

Referring now to FIG. 4, a terminal block 150 is illustrated having reference numerals corresponding to like elements of terminal block 50 incremented by 100 for the purposes of clarity and convenience. Specifically, terminal block 150 extends along a longitudinal axis A-A, and includes a casing 152 that can be formed from any suitable material, for instance Nylon 6-6. Casing 152 includes a mounting portion 154 disposed at its lower end including a clamp configured to connect to a din rail extending along a transverse axis T-T, as understood by one having ordinary skill in the art. A horizontal plate 158 defines the upper end of mounting portion 154. Plate 158 is elongated in the direction of a lateral axis L-L that extends perpendicular with respect to longitudinal axis A-A and transverse axis T-T.

Horizontal plate 158 is recessed with respect to a pair of flanges 159 disposed laterally outward with respect to plate 158, and provides a seat for an electrically conducting member 162.

A vertical end wall 174 extends upwards from plate 158 and defines an inner surface 175. End wall 174 supports a transverse U-shaped guide block 176 that extends inwardly from wall 174. Guide block 176 includes a horizontal wall 179 that is vertically spaced from plate 158 a sufficient distance to accommodate conducting member 162.

Contact block 150 further includes a cover 178 attached to casing 152 via a hinge 180 that can be formed from a section of casing 152 having a reduced thickness so as to render the hinge 180 flexible. A skilled artisan, however, will appreciate that any suitable hinge can be used to connect cover 178 to casing 152. In accordance with one aspect of the invention, cover 178 is hingedly connected to an anchor 153 extending inwardly from end wall 174 at a height substantially equal to that of guide block 176. Cover 178 can be iterated between an open position and a closed position about a pivot axis P′-P′ that extends perpendicular to end wall 174. When cover 178 is in the open position the conducting member 162, and terminals 166 are exposed and accessible to a user. When cover 178 is in the closed position, cover 178 guards the conducting member 162 and terminals 166 from being contacted by a user.

Cover 178 includes a laterally extending wall 182 including a pair of cylindrical apertures 173 extending therethrough, each aperture 173 positioned to be in lateral alignment with a corresponding screw 168 when conducting member 162 is installed. Apertures 173 are sized to allow a conventional screwdriving apparatus to pass through as described above.

Lateral wall 182 is connected at one end to anchor 153 via hinge 180. Anchor 153 includes a horizontal support wall 155 that engages the upper surface of conducting member 162, and a vertical wall 171 extending from a lateral end of end wall 174 at a location laterally outwardly from support wall 155. Hinge 180 extends between vertical wall 171 and one lateral end of lateral wall 182. Cover 178 carries a vertical locating wall 165 that engages vertical wall 171 of anchor 153.

A catch 157 extends inwardly from end wall 174 at the lateral end opposite that of the lateral end supporting anchor 153. Catch 157 includes a horizontal support wall 159 that engages the upper surface of conducting member 162 and cooperates with support wall 155 of anchor 153. A vertical wall 161 extends laterally outwardly from support wall 159 and defines a lip 163 at its upper end.

Cover 178 carries a latch 186 disposed at a free end of the cover 178 that is opposite the end of cover that is directly connected to hinge 180. Latch 186 includes an engagement wall 194 that extends down from lateral wall 182 (when cover 178 is closed) and an outer vertical wall 188 extending parallel to engagement wall 194 and spaced therefrom. A barb 196 extends laterally inwardly from the lower end of engagement wall 194.

During operation, when the electrical power source is discontinued, the user may access terminals 166 with cover 178 in the open position. Prior to activating electrical power through terminal block 150, cover 178 is closed by rotating lateral wall about pivot axis P′-P′. As cover 178 is rotated, barb 196 of latch 186 interlocks with lip 163, which provides a catch to lock cover 178 in the closed position.

When cover 178 is closed, lateral wall 182 extends slightly above conducting member 162 and inwardly from end wall 174 a sufficient distance to guard conducting member 162 and terminals 166. Likewise, anchor 153 and catch 157 are vertically aligned with terminals 166 and conducting member 162 to cooperate with cover 178 in guarding terminals 166 and conducting member 162 when cover 178 is closed.

Advantageously, cover 178 cannot be easily opened by hand, and instead requires a user to insert any suitable biasing member (for example a flathead screwdriver) between engagement wall 194 and vertical wall 188 to remove barb 196 from lip 163 and allow cover 178 to rotate about axis P′-P′ to the open position. It should thus be appreciated that catch 157 and latch 186 provide a locking mechanism that releasably locks cover 178 in the closed position.

Accordingly, terminal block 150 therefore requires a user to have appropriate tooling in order to access terminals 166, and thus reduces the ability of unauthorized personnel from connecting and disconnecting leads to the terminal block 150. The casing 152 further guards the user from accidentally opening cover 178. Furthermore, because cover 178 is attached to casing 152 and easily iterated between the open and closed position, the use of cover 178 is intuitive to skilled personnel.

It should be further appreciated that when cover 178 is open, terminal block 150 provides sufficient user visibility of terminals 166 when connecting and disconnecting electrical leads to terminal block 150 without suffering the drawbacks of conventional open terminal blocks. When cover 178 is closed, terminal block 150 affords the protection currently provided by conventional closed terminal blocks without suffering the drawbacks of conventional closed terminal blocks.

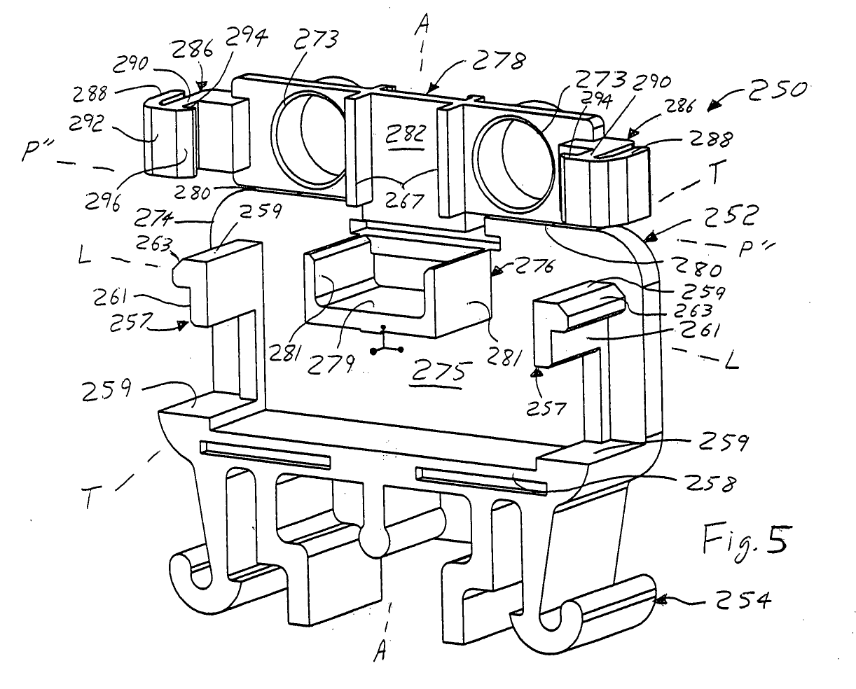

Referring now to FIG. 5, a terminal block 250 is illustrated having reference numerals corresponding to like elements of terminal block 150 incremented by 100 for the purposes of clarity and convenience. Specifically, terminal block 250 extends along a longitudinal axis A-A, and includes a casing 252 that can be formed from any suitable material, for instance Nylon 6-6. Casing 252 includes a mounting portion 254 disposed at its lower end including a clamp configured to connect to a din rail extending along a transverse axis T-T, as understood by one having ordinary skill in the art. A horizontal plate 258 defines the upper end of mounting portion 254. Plate 258 is elongated in the direction of a lateral axis L-L that extends perpendicular with respect to longitudinal axis A-A and transverse axis T-T.

Horizontal plate 258 is recessed with respect to a pair of flanges 259 disposed laterally outward with respect to plate 258, and provides a seat for an electrically conducting member of the type described above.

A vertical end wall 274 extends upwards from plate 258 and defines an inner surface 275. End wall 274 supports a transverse U-shaped guide block 276 that extends inwardly from wall 274. Guide block 276 includes a horizontal wall 279 that is vertically spaced from plate 258 a sufficient distance to accommodate a conducting member of the type described above. A pair of vertical walls 281 extends upwards from opposing lateral ends of horizontal wall 279.

Contact block 250 further includes a cover 278 attached to casing 252 via a pair of hinges 280 that can be formed from sections of casing 252 having a reduced thickness so as to render hinges 280 flexible. A skilled artisan, however, will appreciate that any suitable hinge can be used to connect cover 278 to casing 252. In accordance with one aspect of the invention, cover 278 is hingedly connected to the upper end of end wall 274 and can be iterated between an open position and a closed position about a pivot axis P″-P″ that extends parallel to end wall 274. When cover 278 is in the open position the conducting member and terminals are exposed and accessible to a user. When cover 278 is in the closed position, cover 278 guards the conducting member and terminals from being contacted by a user.

Cover 278 includes a laterally extending wall 282 including a pair of cylindrical apertures 273 extending therethrough, each aperture 273 positioned to be in lateral alignment with a corresponding screw when the conducting member is installed. Apertures 273 are sized to allow a conventional screwdriving apparatus to pass through as described above. Cover 278 further includes a pair of spaced vertical guide walls 267 that engage the laterally inner surfaces of vertical walls 281 when cover 278 is closed.

Cover 278 further carries a pair of latch members 286 extending from both free lateral ends of lateral wall 282. Each latch member 286 includes a support wall 290 extending from lateral wall 282, and an outer wall 288 spaced from support wall 288. Walls 288 and 290 are connected at their distal ends to an engagement wall 292 having an overhang 294 from support wall 290. Engagement wall 292 presents a beveled outer surface 296 at the overhang 294 to assist when locking cover 278.

A corresponding pair of catch members 257 extends inwardly from end wall 174 at opposing lateral ends and aligned with latch members 286. Each catch member 257 includes a vertical wall 261 connected at its upper end to a horizontal wall 259 presenting a beveled upper surface 263.

During operation, when the electrical power source is discontinued, the user may access the terminals and conducting member with cover 278 in the open position. Prior to activating electrical power through terminal block 250, cover 278 is closed by rotating lateral wall about pivot axis P″-P″. As cover 278 is rotated, outer beveled surface 296 of latch 286 cams along beveled surface 263 of catch 257 until overhang 294 interlocks with horizontal wall 259, which provides a catch to lock cover 178 in the closed position.

When cover 278 is closed, lateral wall 282 extends slightly above the conducting member and inwardly from end wall 274 a sufficient distance to guard the conducting member and associated terminals. Likewise, latch 286 and catch 257, when interlocked, are vertically aligned with the conducting member and terminals to cooperate with cover 278 in guarding the conducting member and terminals when cover 278 is closed.

Advantageously, cover 278 cannot be easily opened by hand, and instead requires a user to insert any suitable biasing member (for example a flathead screwdriver) between engagement walls 288 and 290 to remove overhang 194 from horizontal wall 259 and allow cover 278 to rotate about axis P″-P″ to the open position. It should thus be appreciated that latch members 286 and catch members 257 provide a locking mechanism that releasably locks cover 278 in the closed position.

Terminal block 250 therefore requires a user to have appropriate tooling in order to access the terminals, and thus reduces the ability of unauthorized personnel from connecting and disconnecting leads to the terminal block 250. The casing 252 further guards the user from accidentally opening cover 278. Furthermore, because cover 278 is attached to casing 252 and easily iterated between the open and closed position, the use of cover 278 is intuitive to skilled personnel.

It should be further appreciated that when cover 278 is open, terminal block 250 provides sufficient user visibility of the terminals when connecting and disconnecting electrical leads to terminal block 250 without suffering the drawbacks of conventional open terminal blocks. When cover 278 is closed, terminal block 250 affords the protection currently provided by conventional closed terminal blocks without suffering the drawbacks of conventional closed terminal blocks.

The invention has been described in connection with what are presently considered to be the most practical and preferred embodiments. However, the present invention has been presented by way of illustration and is not intended to be limited to the disclosed embodiments. For instance, while certain exemplary terminal blocks have been illustrated and described herein, a skilled artisan will appreciate that the principles of the present invention are equally applicable to any terminal block that would benefit from a cover that is movable between an open and a closed position to guard at least one of the terminals supported by the terminal block. Accordingly, those skilled in the art will realize that the invention is intended to encompass all modifications and alternative arrangements included within the spirit and scope of the invention, as set forth by the appended claims.

1. An individual terminal block comprising:
a casing supporting a first terminal and a second terminal configured to receive electrical connections therein;
a conducting member electrically connecting the first terminal and the second terminal to form a terminal block; and
a cover hingedly affixed to the casing, the cover iterating between an open position that exposes at least one of the terminals and a closed position that guards the at least one exposed terminal.

2. The terminal block as recited in claim 1, wherein the cover exposes both terminals when in the open position, and wherein the cover guards both terminals when in the closed position.

3. The terminal block as recited in claim 1, wherein the casing further comprises an end wall carrying conducting member supporting structure.

4. The terminal block as recited in claim 3, wherein the cover is pivotally connected to extend from the end wall when in the closed position and pivot about a pivot axis such that a free end of the cover rotates about the pivot axis to iterate the cover between the open and closed positions.

5. The terminal block as recited in claim 4, wherein the cover pivots relative to the end wall about an axis extending substantially perpendicular to the end wall.

6. The terminal block as recited in claim 4, wherein the cover pivots relative to the end wall about an axis extending substantially parallel to the end wall.

7. The terminal block as recited in claim 4, further comprising a locking mechanism that interlocks with the free end when the cover is in the closed position.

8. The terminal block as recited in claim 7, wherein the locking mechanism releasably locks the cover in the closed position.

9. The terminal block as recited in claim 4, wherein the casing further comprises 1) an anchor member pivotally connected to the cover, and 2) a catch member interlocking with the free end of the cover when the cover is in the closed position.

10. The terminal block as recited in claim 9, wherein the anchor member and catch member further guard the terminals.

11. The terminal block as recited in claim 4, further comprising a pair of guard arms extending down from opposing ends of the cover when the cover is in the closed position to further guard the terminals.

12. The terminal block as recited in claim 4, further comprising a pair of latch members extending down from opposing ends of the cover when the cover is in the closed position to further guard the terminals.

13. The terminal block as recited in claim 12, wherein the casing further comprises a pair of catch members interlocking with the latch members when the cover is closed, wherein the catch members further guard the terminals.

14. The terminal block as recited in claim 1, wherein the cover defines at least one aperture providing access to the at least one guarded terminal when the cover is closed.

15. A method for operating an individual terminal block of the type including a casing, a conducting member supported by the casing, and a first terminal and second terminal, each terminal electrically connected to the conducting member, and a cover hingedly affixed to the casing, the method comprising the steps of:
(A) mounting the single terminal on a mounting rail to secure the single terminal block in a position to receive wires;
(B) connecting at least one electrical wire from an electrical device to at least a corresponding one of the first and second terminals;
(C) pivoting the cover with respect to the casing between an open and a closed position, whereby the cover blocks access to at least one of the first and second terminals when in the closed position, and whereby the blocked terminal is accessible when the cover is in the open position; and
(D) locking the cover in the closed position to restrict access to the first and second terminals single terminal block.

16. The method as recited in claim 15, wherein the cover is affixed to the casing and includes a free end, wherein step (E) further comprises interlocking the free end of the cover with the casing.

17. The method as recited in claim 15, wherein the casing further comprises an end wall carrying conducting member supporting structure, and wherein step (C) further comprises pivoting the cover about an axis extending substantially perpendicular to the end wall.

18. (canceled)

19. The method as recited in claim 15, wherein the casing further comprises an end wall carrying conducting member supporting structure, and wherein step (C) further comprises pivoting the cover about an axis extending substantially parallel to the end wall.

20. An individual terminal block comprising:
a casing including an end wall;
a mounting clamp configured to connect to a DIN rail extending along a transverse axis of the casing;
a conducting member supported by the casing;
a first terminal and a second terminal, each terminal electrically connected to the conducting member;
a cover hingedly affixed to the casing, the cover iterating between an open position that exposes at least one of the terminals and a closed position that guards the exposed terminal; and
a locking mechanism that releasably locks the cover in the closed position.

21. The method as recited in claim 15, wherein the step (A) further includes securing a mounting clamp in a DIN rail extending transversely to the casing.
